(19) United States
(12) Patent Application Publication
(10) Pub. No.: US 2008/0014126 A1
(43) Pub. Date: Jan. 17, 2008

(54) PROCESS AND APPARATUS FOR GENERATING HYDROGEN AND HYDROGEN-CONTAINING GAS MIXTURES

(75) Inventors: Peter BENDER, Muenchen (DE); Stephanie Neuendorf, Hohenschaeftlarn (DE); Nicole Schoedel, Muenchen (DE); Hubertus Winkler, Grainau (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/775,737

(22) Filed: Jul. 10, 2007

(30) Foreign Application Priority Data
Jul. 11, 2006 (DE) 10 2006 032 104.9

(51) Int. Cl. C01B 3/02; C01B 3/26; B01J 19/00; C01B 31/18; B01J 8/00

(52) U.S. Cl. 422/129; 423/652; 422/187; 423/418.2; 423/652

(57) ABSTRACT

A process and apparatus for converting starting materials containing hydrocarbon into a hydrogen-rich product gas is disclosed. A raw synthesis gas containing hydrogen (H₂) and carbon monoxide (CO) is generated from the hydrocarbon-containing starting materials in a first process step of which at least a part undergoes a catalytically supported water-gas shift reaction to increase the percentage of hydrogen. The water-gas shift reaction is carried out at temperatures between 50 and 200° C., preferably between 60 and 150° C., and at temperatures between 1 and 10 bar, preferably between 1 and 5 bar, in a reactor in which a suitable catalyst is present.

This application claims the priority of German Patent Document No. 10 2006 032 104.9, filed Jul. 11, 2006, the disclosure of which is expressly incorporated by reference herein.

### BACKGROUND AND SUMMARY OF THE INVENTION

The invention relates to a process and apparatus for converting carbon-containing starting materials into a hydrogen-rich product gas, where a raw synthesis gas containing hydrogen (H₂) and carbon monoxide (CO) is generated in a first process step from the carbon-containing starting materials of which at least one part undergoes a catalytically supported water-gas shift reaction to increase the percentage of hydrogen.

A number of processes are known for generating hydrogen and hydrogen-containing gas mixtures which are used as raw materials in a plurality of technical applications. In a process of this type, carbon-containing starting materials are converted by incomplete burning (partial oxidation) while in another process a hydrocarbon-containing starting material is converted together with steam at increased temperature in a catalytically supported reaction. The extraction of hydrogen through thermal decomposition (pyrolysis) of hydrocarbon, for example, is further known. A gas mixture (raw synthesis gas) is generated in all these processes which contains, in addition to hydrogen, carbon monoxide, carbon dioxide, water and unconverted quantities of the starting material and possibly also dusts and tars. If air was used in the conversion of the starting material, the gas mixture generated contains atmospheric nitrogen.

In order to increase the hydrogen yield in the conversion of carbon-containing starting materials, the raw synthesis gas (often after cleaning) undergoes a catalytically supported water-gas shift reaction in which carbon monoxide is converted into carbon dioxide and hydrogen using water. Depending on the type of catalyst used, the conversion is described as high-, medium- or low-temperature.

It is not possible to convert the carbon monoxide in a synthesis gas completely into hydrogen by high-temperature conversion such as is frequently used for reasons of simple execution and high catalyst stability and which runs at temperatures between 300 and 450° C. Limited by the reaction balance, the conversion product contains a CO content of up to 2.5%. In order to convert the remaining carbon monoxide as well, the product gas is often taken from a high-temperature conversion to a low-temperature conversion which is carried out at temperatures between 180 and 250° C. In this way it is possible to convert almost all the CO into hydrogen using water, but the technical and financial investment required for this is substantial. In addition, because of the residual CO content, post-cleaning of the hydrogen in a pressure change absorption is necessary.

In the extraction of hydrogen from biomass, wood, for example, is converted into a synthesis gas by pyrolysis which is augmented with dusts, tars and aromatic compounds and for this reason can only undergo a water-gas shift reaction following a gas wash. Since the temperature of the synthesis gas in the usual wash processes is lowered to readings of less than 180° C., it cannot be treated immediately after one of the conversion processes as in prior art hydrogen extraction. It is necessary to increase the synthesis gas temperature before the conversion step, which impacts the economy of the process.

In accordance with the present invention, the water-gas shift reaction is performed at temperatures between 50° C. and 200° C., preferably between 60° C. and 150° C., and at pressures between 1 and 10 bar, preferably between 1 and 5 bar, in a reactor (water-gas shift reactor) in which a suitable catalyst is present.

Since the hydrogen accumulating during the water-gas shift reaction in accordance with the invention in the water-gas shift reactor is present at low pressures between 1 and 10 bar, the reaction balance can be shifted to high hydrogen yields at low temperatures of 60° C. to 150° C. For this reason, the temperature of the raw synthesis gas is preferably between 60° C. and 150° C.

If the water content of the raw synthesis gas is too low to meet the water requirement of the water-gas shift reaction taking place in the water-gas shift reactor, a variant of the inventive process makes provision for adding water before its introduction into the water-gas shift reactor so that the water content of the raw synthesis gas is increased to a value which is high enough to meet the water requirement of the water-gas shift reaction taking place in the water-gas shift reactor.

Frequently, in addition to the desirable materials, e.g., H₂, CO, the raw synthesis gases contain undesirable materials such as tars or dusts. Since such materials cause blockages during the gas flow through packed beds such as are usually present in a water-gas shift reactor, one embodiment of the inventive process makes provision for raw synthesis gas to be supplied to the water-gas shift reactor which is free of undesirable materials. A cleaning step is expediently provided ahead of the water-gas shift reactor in which undesirable materials are removed from the raw synthesis gas. The cleaning step is preferably performed by means of a water wash.

A preferred embodiment of the invention therefore provides that the hydrocarbon-containing starting materials are converted by pyrolysis (low-pressure pyrolysis) into raw synthesis gases at low pressures of less than 12 bar. Since raw synthesis gases generated in this manner frequently contain aromatic compounds, tars, dusts, it is necessary to clean the raw synthesis gas before further processing. If the cleaning is performed in a water wash, the raw synthesis gas that comes out of pyrolysis at a temperature of around 850° C. is cooled down to temperatures between 50 and 200° C. and simultaneously saturated with water and can therefore be taken immediately after the water wash and without an additional process step to the inventive water-gas shift reaction.

Another preferred embodiment of the invention provides that materials produced by biological methods, such as wood or straw for example, are used as hydrocarbon-containing starting materials.

A further preferred embodiment of the invention provides that a supported ionic liquid phase (SILP) reactor is used as the water-gas shift reactor in which a suitable catalyst is present in an ionic fluid immobilized on a substrate. This system of catalyst, ionic fluid and carrier material is present as a solid and can correspondingly be designed as a fixed-bed reactor. The advantage of this design is that complicated catalyst systems, for example metal-organic catalyst systems, can also be used which otherwise are accessible only to homogenous catalytic applications. Additional advantages of the SILP reactor are the generally high attainable selectivities with simultaneously high turnover rates which permit a smaller and more compact reactor design.

For many processes, such as the synthesis of fuels in a Fischer-Tropsch plant, a starter is needed which has hydrogen and carbon monoxide in a fixed ratio. In order to produce such a starter using the invention, it is provided that a part of the raw synthesis gas is taken in the bypass to the water-gas shift reactor and combined with the product from the water-gas shift reactor into a hydrogen-rich product gas, where the variable of the bypass-stream is controlled such that the H₂/CO ratio in the hydrogen-rich product gas corresponds to a specified value.

In the classic pyrolysis processes with subsequent high and/or low temperature CO conversion, compression of the raw synthesis gas takes place before the water-gas shift reaction, where the water content of the raw synthesis gas is not favorable to compression. If the pressure of the hydrogen-rich product gas coming from the water-gas shift reactor is too low for further use (for example, in a fuel cell), a variant of the inventive process provides for the product gas to be cleaned of water in a water separator and compressed subsequently—substantially more efficiently than the water-containing gas. The water is expediently condensed out in the water separator by lowering the temperature and then removed from the product gas.

Among the known types of compressors are the piston compressor and the screw compressor, both of which are volumetric compressors. Among the newer developments are the turbo compressor, such as axial or radial compressors. All these types of compressors have, however, only limited suitability for the compression of explosive mixtures, which include a hydrogen-rich product gas, since ignition sources could be created through mechanical friction in the compression chamber. Water ring compressors are suitable for compressing explosive mixtures but they are expensive because of their complex mechanical construction.

In the publication WO 2006/034748, the entire disclosure of which is hereby incorporated by reference herein in its entirety, compressors are described for compressing hydrogen-rich gases in particular which do not have the disadvantages described above. Further developing the invention, it is provided that a compressor as described in WO 2006/034748 is used to increase the pressure of the hydrogen-rich product gas.

### BRIEF DESCRIPTION OF THE DRAWING

FIG. 1 is a schematic representation of an embodiment of the present invention.

### DETAILED DESCRIPTION OF THE DRAWING

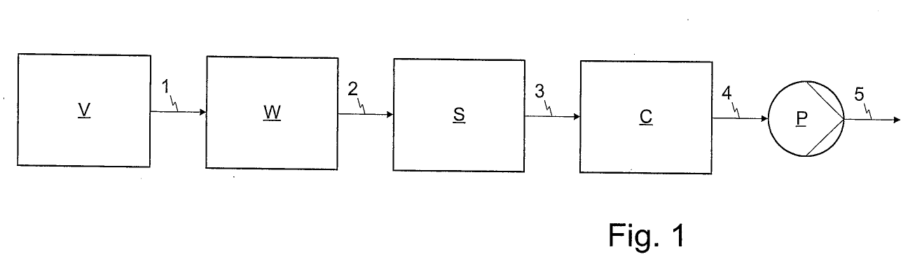

The embodiment of FIG. 1 concerns a process and apparatus for generating hydrogen from wood chips.

In the biomass gasifier V a raw synthesis gas containing hydrogen and carbon monoxide is generated from the wood chips by pyrolysis at low pressure and taken at a temperature of approximately 850° C. over line 1 to the gas wash W. In the gas wash, which is designed as a water wash, undesirable materials such as aromatic compounds, tars and dusts are washed out of the raw synthesis gas, whereby the temperature drops to approximately 100° C. and the raw synthesis gas is saturated with water. From the water wash W, the cleansed raw synthesis gas is taken over line 2 to the SILP reactor S to perform a water-gas shift reaction. The reactor contains a suitable catalyst and the carbon monoxide present in the raw synthesis gas, catalytically supported by water, is converted into hydrogen and carbon monoxide except for a few ppm. The product gas which contains other components besides hydrogen such as carbon dioxide and water is drawn off from the SILP reactor and taken to the water separator C in which water is condensed out and removed from the product gas. A gas mixture consisting almost entirely of hydrogen and carbon dioxide is drawn off over line 4 and conducted to the compressor P from which the gas mixture flows at increased pressure over line 5 and is taken for further processing (not shown).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for converting starting materials containing hydrocarbon into a hydrogen-rich product gas, wherein a raw synthesis gas containing hydrogen (H₂) and carbon monoxide (CO) is generated from the starting materials containing hydrocarbon in a first process step of which at least a part undergoes a catalytically supported water-gas shift reaction to increase a percentage of hydrogen, wherein the water-gas shift reaction is carried out at temperatures between 50 and 200° C. and at pressures between 1 and 10 bar in a reactor in which a suitable catalyst is present.

2. The process according to claim 1, wherein the water-gas shift reaction is carried out at temperatures between 60 and 150° C.

3. The process according to claim 1, wherein the water-gas shift reaction is carried out at pressures between 1 and 5 bar.

4. The process according to claim 1, wherein the starting materials containing hydrocarbon are converted at low pressures of less than 12 bar by pyrolysis into the raw synthesis gas.

5. The process according to claim 1, wherein the raw synthesis gas undergoes a gas wash using water before it is introduced into the water-gas shift reactor.

6. The process according to claim 1, wherein the starting materials containing hydrocarbon are materials created by biological methods.

7. The process according to claim 1, wherein a supported ionic liquid phase reactor is used as the water-gas shift reactor in which the suitable catalyst is present in an ionic fluid immobilized on a substrate.

8. The process according to claim 1, wherein a part of the raw synthesis gas is taken in a by-pass to the water-gas shift reactor and combined with a product from the water-gas shift reactor into the hydrogen-rich product gas, where a variable of a by-pass stream is controlled such that an H₂/CO ratio in the hydrogen-rich product gas corresponds to a specified value.

9. A process for converting starting materials containing hydrocarbon into a hydrogen-rich product gas, comprising the steps of:
generating a raw synthesis gas containing hydrogen (H₂) and carbon monoxide (CO) from the starting materials; and
performing a catalytically supported water-gas shift reaction on at least a part of the raw synthesis gas to increase a percentage of hydrogen, wherein the water-gas shift reaction is carried out at temperatures between 50 and 200° C. and at pressures between 1 and 10 bar in a reactor.

10. The process according to claim 9, further comprising the step of water washing the raw synthesis gas prior to the step of performing the catalytically supported water-gas shift reaction.

11. The process according to claim 9, wherein in the catalytically supported water-gas shift reaction, the carbon monoxide in the raw synthesis gas is converted into hydrogen and carbon monoxide.

12. The process according to claim 9, further comprising the steps of condensing and removing water from a product gas produced by the catalytically supported water-gas shift reaction to form a gas mixture.

13. The process according to claim 12, further comprising the step of compressing the gas mixture.

14. The process according to claim 9, further comprising the step of combining a part of the raw synthesis gas with the part of the raw synthesis gas on which was performed the catalytically supported water-gas shift reaction.

15. An apparatus for converting starting materials containing hydrocarbon into a hydrogen-rich product gas, comprising:
a biomass gasifier, wherein a raw synthesis gas containing hydrogen (H₂) and carbon monoxide (CO) is generatable from the starting materials in the biomass gasifier; and
a reactor coupled to the biomass gasifier, wherein a catalytically supported water-gas shift reaction is performable in the reactor on at least a part of the raw synthesis gas, and wherein the water-gas shift reaction is performable at temperatures between 50 and 200° C. and at pressures between 1 and 10 bar.

16. The apparatus according to claim 15, further comprising a water wash coupled to the reactor.

17. The apparatus according to claim 15, further comprising a water separator coupled to the reactor.

18. The apparatus according to claim 17, further comprising a compressor coupled to the water separator.

19. The apparatus according to claim 15, further comprising a reactor by-pass.

20. The apparatus according to claim 15, wherein the reactor is a supported ionic liquid phase (SILP) reactor.
